(19) United States
(12) Patent Application Publication
(10) Pub. No.: US 2021/0319491 A1
(43) Pub. Date: Oct. 14, 2021

(54) Methods and Systems for Vendor Selection for Enterprise Resource Planning Systems

(71) Applicant: Fairmarkit, Inc, Malden, MA (US)

(72) Inventors: Viktar Kushch, Newton, MA (US); Vlad Hamolia, Newton, MA (US)

(21) Appl. No.: 17/080,918

(22) Filed: Oct. 27, 2020

Related U.S. Application Data
(60) Provisional application No. 62/905,309, filed on Sep. 24, 2019.

(51) Int. Cl. G06Q 30/06; G06Q 30/08; G06Q 10/06; G06F 16/9535; G06F 16/2457

(52) U.S. Cl. CPC G06Q 30/0631; G06Q 30/08; G06Q 10/0639; G06Q 30/0202; G06F 16/9535; G06F 16/24578; G06Q 10/06313

(57) ABSTRACT

A system and method for vendor pooling and contract auctions for enterprise that have enterprise resource planning (ERP) software. A software program with ranking algorithms, machine learning functions and online auction capabilities. A cloud network that interacts with ERP networks. Purchasing data from ERP software (e.g., vendor contracts, purchase orders, invoices and receipts, etc.) and the vendor data (e.g., pricing, stock availability, delivery rates, etc.) are continually uploaded to the cloud. Algorithms automatically examine the data, establish a vendor pool, and rank vendor performance. The rankings are automatically fed back into the ERP and are used in making a requisition request for an online auction in real time. Another object is to enhance the vendor vetting process for company purchases.

### RELATED APPLICATIONS

This application claims the benefit under 35 USC 119(e) of U.S. Provisional Application No. 62/905,309, filed on Sep. 24, 2019, which is incorporated herein by reference in its entirety.

### FIELD OF THE INVENTION

The present inventions generally relate to the vendor selection. More specifically, it relates to software that interacts with a user's enterprise resource planning system, gathers transaction data, and recommends a vendor when the user requests a needed item or service outside of their enterprise.

### BACKGROUND

In many enterprises, an employee can purchase products through the procurement infrastructure offered by the enterprise. The number of products offered through the procurement services of the enterprise may be extremely large.

ERP is usually referred to as a category of business management software—typically a suite of integrated applications—that an enterprise can use to collect, store, manage, and interpret data from many business activities.

ERP provides an integrated and continuously updated view of core business processes using common databases maintained by a database management system. ERP systems track business resources—cash, raw materials, production capacity—and the status of business commitments: orders, purchase orders, and payroll. The applications that make up the system share data across various departments (manufacturing, purchasing, sales, accounting, etc.) that provide the data. ERP facilitates information flow between all business functions and manages connections to outside stakeholders.

The ERP system integrates varied enterprise systems and facilitates error-free transactions and production, thereby enhancing the enterprise's efficiency.

Enterprise Resource Planning (ERP) software emerged with early main frame computers in the 1960s. The first ERP was a joint effort between tractor manufacturer Case Corporation and IBM, its technology partner. This collaboration further led to the creation of software known as Materials Requirements Planning (MRP). MRP in the 1970s helped plan raw material requirements for manufacturing, purchasing, and delivery. By 1975, MRP software was running in hundreds of large companies and was affordable only to large firms. In 1972, the firm SAP was started in Germany to establish a business platform that worked in real time. In the 1980s, MRP evolved to what was known as MRP II, or Manufacturing Resource Planning by adding more manufacturing processes and capabilities to enable functioning as one-stop production planning solution. The term ERP—Enterprise Resource Planning—was first used in the 1990s and such systems dealt with other business functions like engineering, finance and accounting, HR and project management, etc. The approach was to have modular applications with advanced features. All the systems in the 1990s used legacy on-premise models until NetSuite came into being in 1996. NetSuite created an ERP system that worked across business functions of a company but was not on-premise and was delivered over the internet. In 2000, Gartner Group defined ERP II as internet-enabled software that gave real-time access to the ERP solution. It also provided functionalities outside of the business management, like supply chain management, customer relationship management (CRM), and business intelligence. After 2005, ERPs became linked to cloud software solutions and moved away from the traditional local client/server models. Cloud ERP software solutions provided comparable functionalities to on-premise ERP at a much lower cost and became more attractive, especially for small and mid-sized businesses.

Today's cloud ERP systems cover every aspect of business operation. They have advanced reporting, analytics, business intelligence tools, and functionalities. These systems continue to improve.

Developers now make more effort to integrate mobile devices with the ERP system. ERP vendors are extending ERP to these devices, along with other business applications. Technical stakes of modern ERP concern integration include hardware, applications, networking, supply chains. ERP now covers more functions and roles including decision making, stakeholders' relationships, standardization, transparency, globalization, etc.

ERP systems may, without limitation, include the following characteristics:

an integrated system;

operates in (or near) real time;

a common database that supports all the applications;

a consistent look and feel across modules;

installation of the system with elaborate application/data integration by the Information Technology (IT) department, provided the implementation is not done in small steps;

deployment options include: on-premises, cloud hosted, or SaaS

An ERP system may, without limitation, cover the following common functional areas. In many ERP systems, these are called and grouped together as ERP modules:

financial accounting: general ledger, fixed assets, payables including vouchering, matching and payment, receivables and collections, cash management, financial consolidation;

management accounting: budgeting, costing, cost management, activity based costing;

human resources: recruiting, training, rostering, payroll, benefits, retirement and pension plans, diversity management, retirement, separation;

manufacturing: engineering, bill of materials, work orders, scheduling, capacity, workflow management, quality control, manufacturing process, manufacturing projects, manufacturing flow, product life cycle management;

order processing: order to cash, order entry, credit checking, pricing, available to promise, inventory, shipping, sales analysis and reporting, sales commissioning;

supply chain management: supply chain planning, supplier scheduling, product configurator, order to cash, purchasing, inventory, claim processing, warehousing (receiving, put away, picking and packing);

project management: project planning, resource planning, project costing, work breakdown structure, billing, time and expense, performance units, activity management;

customer relationship management (CRM): sales and marketing, commissions, service, customer contact, call center support—CRM systems are not always considered part of ERP systems but rather business support systems (BSS);

data services: various self-service interfaces for customers, suppliers and/or employees.

### BRIEF SUMMARY

The disclosure provides systems and methods for vendor recommendations within existing ERP systems. An object of the inventions is to enhance and streamline the vendor selection process when a request for a product or service originates within an enterprise's ERP system. The software continually ranks enterprise's existing vendors in real time, for example, based on their performance.

For example, an enterprise employee is interested in purchasing a set of new tools for a process on the manufacturing floor. The employee logs into the website and enters the tool name needed. The software automatically searches vendors who have experience of delivering similar items within the same domain, sell such items, and have worked in the past with the enterprise and/or other enterprises.

The software selects the most appropriate vendors based, for example, on the search and ranking model and establishes a sourcing/bidding event. Via this event, each selected vendor can submit a bid for the request. The bids may include pricing, delivery conditions, and other details related to supplying these goods and/or services. After the enterprise employee reviews the submitted bids and picks the most appropriate bid or bids (e.g., best suited for the specific request), the software sends a vendor recommendation list or an updated bid proposal with metadata, if necessary, to the ERP system to allow the employee to quickly decide in the best interest of the company without having to conduct a time-consuming vendor research and follow-ups.

Another object of the inventions is to provide a means to rank vendors utilizing criteria set forth in several algorithms, for example, using timing criteria. The software gathers all transactional data from an enterprise's ERP involving vendors and combs through and looks for performance indicators. These indicators may include pricing, stock availability, delivery times, refunds, vendor response patterns, etc. The software compares the indicators among vendors in the vendor pool and, dynamically for each specific requested item or service, assigns each a risk score, ranking and weighting each vendor under consideration.

Another object of the inventions is to provide a means to allow a live bidding process to take place in order to compete for a company's business. For example, vendors who have been selected for inclusion into a pool of recommended vendors for a purchase request are then invited to submit a bid on a job or product. Similar to other online auction systems (such as eBay, etc.) auctions are set up by the user for a specific timeframe and the winning vendor is notified automatically that a contract is awarded.

Another object is to promote vendor performance awareness. Vendors who participate in the database are afforded access to the performance rankings generated by the software. Another feature of the software includes machine learning that analyzes a vendor's transactional activities with businesses and makes predictions based on these historical transactions. For example, if a vendor continually fails to secure contracts with businesses, they can review their prediction scores and forecast whether they will be selected for contracts in the future. Such forecasting helps businesses to realize therefore and improve their performance in an effort to gain future contracts.

Another object is to automatically drive and improve the vendor/supplier diversity (for example, with respect to women-owned businesses, minority-owned businesses, etc.) across multiple purchasing events within the enterprise by using diversity metadata in the ranking algorithms and creating a setup requiring a set amount of diversity vendors.

In general, the disclosed solutions also minimize risks within the vendor selection process, enhance purchasing power, reduce sourcing time, and/or mitigate three and more bids compliance.

The embodiments include a system for vendor recommendations and running online auctions comprising software and a cloud network.

The embodiments also include a method for vendor recommendations and running online auctions comprising searching ERP transaction data; ranking vendors; establishing a pool of vendors; referring vendors; conducting an online auction; and predicting vendor performance.

Some embodiments comprise ERP transaction data searching wherein the data are gathered from historical financial transactions between a user's enterprise and a vendor.

Some embodiments comprise establishing a pool of vendors based on a set of manufacturer criteria.

In some embodiments, the recommendations are transmitted to a user's ERP.

In some embodiments, the auction members comprise the recommended vendors.

In some embodiments, the vendor performance is performed by machine learning algorithms in the software.

It is briefly noted that upon reading this disclosure, those skilled in the art will recognize various means for carrying out these intended features of the invention. As such it is to be understood that other methods, applications and systems adapted to the task may be configured to carry out these features and are therefore considered to be within the scope and intent of the present inventions and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The inventions herein described are capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present inventions.

The objects, features, and advantages of the present inventions, as well as the advantages thereof over existing prior art, which will become apparent from the description to follow, are accomplished by the improvements described in this specification and hereinafter described in the following detailed description which fully discloses the invention but should not be considered as placing limitations thereon.

### BRIEF DESCRIPTION OF THE SEVERAL VIEWS OF THE DRAWINGS

The accompanying drawings, which are incorporated herein and form a part of the specification, illustrate some, but not the only or exclusive, examples of embodiments and/or features.

FIG. 1 shows an embodiment in use.

FIG. 2 shows a flow chart of an embodiment's general process.

FIG. 3 shows an embodiment's structure and use.

Other aspects of the present invention shall be more readily understood when considered in conjunction with the accompanying drawings, and the following detailed description, neither of which should be considered limiting.

### DETAILED DESCRIPTION

Description of the approximate embodiments is presented below. However, the inventions are not limited only to these embodiments. It will be obvious to persons who are experienced in this field that other embodiments may fall within the scope of the present group of inventions.

The invention in its various implementation options can be implemented in the form of computer ERP systems and methods, as well as in the form of a computer-readable data carrier.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

FIG. 1 shows an embodiment where outside vendors 6 and 7 are being notified about a potential contract with a user 3 (for example, an authorized or a designated buyer within an enterprise) by examining a mobile device software application 4 on their smart phones 5. The user 3 interacts with the web-based cloud network platform software 1 using a desktop computer 2. The software uses a code written, for example, in Java, C++, Visual Basic, Linux, Basic, etc. The software is also compatible with a plurality of operating systems such as, but not limited to: Windows, Apple OS, and Android, and is compatible with a multitude of hardware platforms such as, but not limited to: personal desktops, laptops, tablets, smartphones, etc.

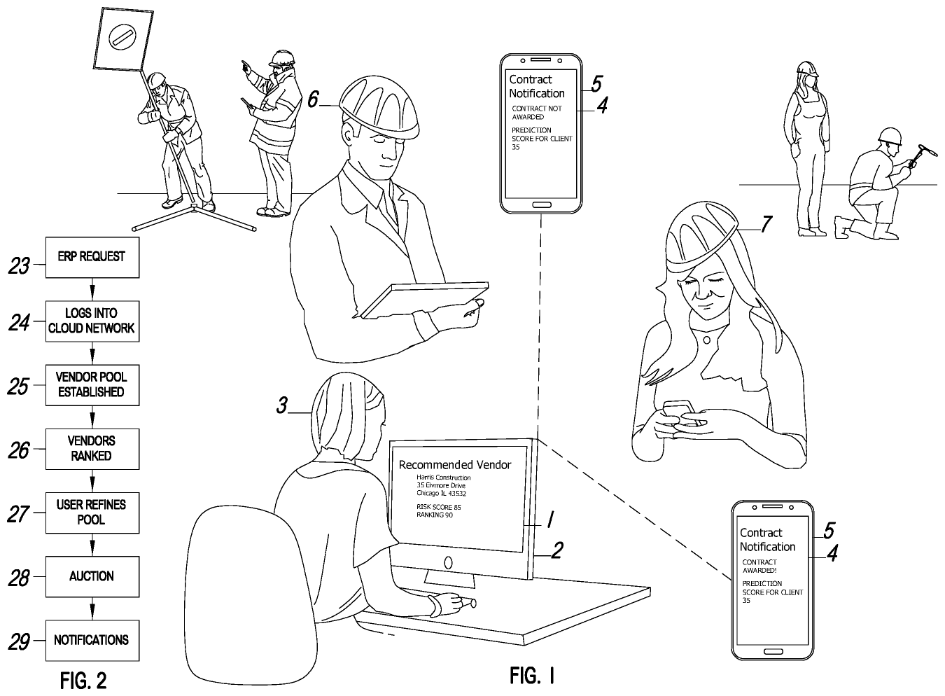

FIG. 2 is a process flow chart. A user 3 (for example, an authorized or a designated buyer within an enterprise) generates a product or service request on an internal ERP system 23 and then logs onto the cloud network 24, which may be provided by subscription. The software 1 receives the request, extracts keyword data, and establishes, selects, or determines a vendor pool 25 for the request. The vendor pool is a number of vendors determined, for example, by a ranking algorithm among a plurality of vendors authorized to do business with the enterprise. The user 3 receives the recommended vendor pool on their local ERP system 27 and either chooses the best vendor for the request or determines which vendors to include in an auction 28 for the requested item or service.

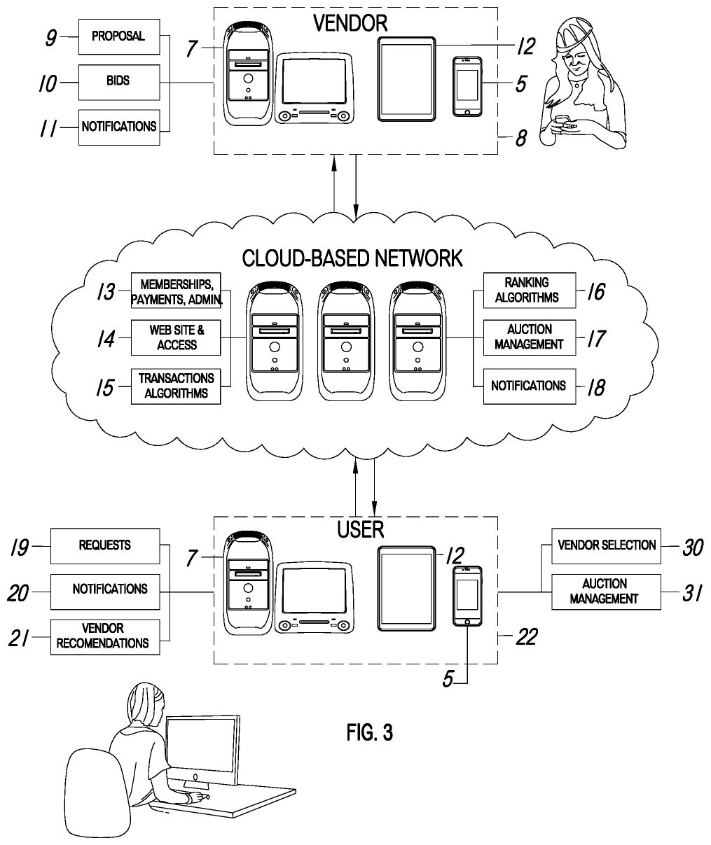

FIG. 3 shows a user (for example, an employee, a requester, an authorized/designated buyer) within an enterprise generating a new purchase request for a new product or service on an ERP platform, for example, SAPTM, Oracle Peoplesoft, Coupa, Workday, etc. The requests 19 are transferred to the cloud-based network. The user receives notifications 20 from the cloud network using computing devices such as but not limited to desktop computers 7, tablets 12, and smart phones 5. These notifications may include but not be limited to vendor recommendations 21, contract statuses, as well as direct communications with the vendors/contractors. Other user functions include a final vendor selection for inclusion into an auction 30, managing online auctions 31 on the server (including but not limited to setting prices, timelines, etc.).

The cloud-based network in FIG. 3 further includes such functions and parts as membership management 13 (including online payments, archives, etc.), a front-end website with graphical user interface 14, and a back-end server containing algorithms 15 and epic functions that may include user transaction data scraping (such as purchase orders, transactions, invoices, receipts, packing slips using N-grams, elastic searches, etc.).

The server and the cloud-based network include ranking algorithms 16 that establish a pool of recommended vendors based upon averaging/processing historical ERP user transaction data with classifications that may include: historical records of specific items and/or services sold; general domains of vendors by their transactions (where, for each vendor, the system checks if the requested item is similar with regard to the product domain); semantic similarity (measuring the semantic context of the request, not only a lexicographical similarity); and dynamic vendor rank based on the vendors' performance in the relevant product domains (the domain detection is performed using Transformer-Based Deep Neural Networks). The vendor items/services may have searchable options/attributes, such as the United Nations Standard Products and Services Code (UNSPSC) listings, etc.

A product domain is a domain group of relating products or services. Within an enterprise, there are normally several identifiable product domains, reflected also in the enterprise's internal language. There may be several enterprise units, each in charge of one product domain.

Once a vendor pool is established/selected, the software applies a quantitative ranking algorithm (e.g., based on averages) to each vendor based on factors such as but not limited to: how close the vendor prices are to a preset user benchmark; the vendor pricing history, the vendor delivery time and performance history, the successful sales history with the vendor, etc. Other algorithms comparing the factors for one vendor against other vendors in the selected vendor pool may be used. The server may also include machine learning capabilities for vendors. The machine learning is used to predict whether or not a vendor has a chance of winning a contract and how high this probability is based on the criteria such as but not limited to: how close prices are to a preset user benchmarks; vendor price history, vendor delivery time history, successful sales history, etc.

The cloud-based network comprises an online auction management tools 17 (for setting prices, accepting bids, etc.) as well as a notifications module 18 using, for example, SMS, text messaging and emails, etc. The vendor 8 may be provided with functions including but not limited to generating proposals 9 (which may include generating electronic letters and emails, etc.); participating in auctions and setting bids 10; and receiving notifications such as but not limited to contract awards and machine learning prediction scores associated with their performance in relation to the user using desktop computers 7, tablets 12, smart phones 5, etc.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

The embodiments can use software, hardware, software logic, or their combination. In this embodiment examples, software logic, software, or a set of instructions may be stored on one or multiple various conventional computer-readable data carriers.

In the context of this description, a “computer-readable data carrier” may be any environment or medium that can contain, store, transmit, distribute, or transport the instructions (commands) for their application (execution) by a computer device, such as a personal computer. Thus, a data carrier may be an energy-dependent or energy-independent machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the invention is not limited to the embodiments disclosed and, moreover, is intended to modify and combine various other features of the embodiments described. For example, it should be understood that this invention implies that, to the possible extent, one or more features of any embodiment may be combined with one or more other features of any other embodiment.

1. A system for vendor recommendations and running online auctions system comprising:
software; and
a cloud network.

2. A method for vendor recommendations and running online auctions comprising:
searching ERP transaction data;
ranking vendors;
establishing a pool of vendors;
reporting vendors;
conducting an online auction; and
predicting vendor performance.
